(19) United States
(12) Patent Application Publication
(10) Pub. No.: US 2016/0267437 A1
(43) Pub. Date: Sep. 15, 2016

(54) INTEGRATED STAFFING SYSTEM OVER A NETWORK

(71) Applicant: ABC Employment Holdings, LLC, Indianapolis, IN (US)

(72) Inventor: Zach Gray, Indianapolis, IN (US)

(21) Appl. No.: 15/067,393

(22) Filed: Mar. 11, 2016

Related U.S. Application Data
(60) Provisional application No. 62/132,967, filed on Mar. 13, 2015.

(51) Int. Cl. G06Q 10/10

(52) U.S. Cl. CPC G06Q 10/1053

(57) ABSTRACT

A system for managing staffing functions including an integrated staffing system communicatively coupled to the network, the integrated staffing system being configured to establish a data interface between at least one employer, a plurality of employees, and a staffing agency, capture employee information from the plurality of employees via the data interface, assign predetermined point values to the employee information captured from each of the plurality of employees, create a market opportunity list based at least in part on the point values assigned to each of the employees, and determine a market opportunity based at least on part on the employee information.

### CROSS REFERENCE TO RELATED APPLICATIONS

The present application is related to, and claims the priority benefit of, U.S. Provisional Patent Application Ser. No. 62/132,967 filed Mar. 13, 2015, the contents of which are hereby incorporated in their entirety into the present disclosure.

### FIELD OF INVENTION

The present invention relates to techniques for managing aspects of staffing, and more particularly to a system and method for integrating staffing functions over a network.

### BACKGROUND

In many industries, skilled personnel are needed to fill specific staffing needs. When a staffing need arises (e.g., if a currently scheduled staff member falls ill), the opening needs to be filled by someone with the requisite skills, qualifications, certifications, licenses and/or time. Using current methods, evaluating staffing needs and finding individuals that satisfy those staffing needs are time consuming and inefficient. Those individuals are then contacted using a traditional telephone (POTS) by, e.g., a staffing agency, to determine whether each individual is available to fill the staffing need. The use of a staffing agency and the cumbersome processes involved in filling the staffing need increases costs and reduces efficiency. There is therefore a need to more efficiently select qualified personnel to meet the staffign requirements.

### SUMMARY OF THE DISCLOSED EMBODIMENTS

In one aspect, a network architecture is provided. The network includes one or more client computers with an integrated staffing system hosted on a server. The network serves to connect one or more client computers, one or more customer computers, and one or more staff computers with the integrated staffing system hosted on the server. The one or more client computers one or more customer computers, and one or more staff computers can also connect to the network via a network service provider, such as an internet service provider (ISP).

The integrated staffing system is configured to establish a data interface between at least one customer, a plurality of clients, and a staffing agency. The integrated staffing system is further configured to capture work assignment information from the at least one customer via a customer portal, capture client information from the plurality of clients via a client portal, operate a staffing portal to utilize a point system based at least in part on the employee information to prioritize the plurality of employees to form a market opportunity list, and determine a market opportunity based at least on part on the market opportunity list.

The clients interact with the client portal of the integrated staffing system via the client computer, customers interact with the customer portal of the integrated staffing system via the customer computer, and staffing interact with the staffing portal of the integrated staffing system via the staffing computer.

A customer may interact with the integrated staffing system via the customer portal. The customer portal is used by customers, and configured to capture work assignment information for certain positions or particular projects on an as needed basis. In an embodiment, the work assignment information includes at least one job opening, at least one requirement for each of the at least one job opening, and a location for each of the at least one job openings.

In an embodiment, the customer may also choose to start a new work assignment via a starting project option; view a list of open work assignments via an open project option; or view a list of closed work assignments via a closed project option. The customer may also review any documents associated with their account and stored on the server via a documents option. In one embodiment, the customer portal is further configured to capture performance data for each of the clients relative to a work assignment. In an embodiment, the customer may view and generate a report of the performance data related to any particular work assignment.

A potential client may interact with the integrated staffing system via an application portal. The application portal is configured to capture employee information from a plurality of potential clients. In an embodiment, to create an employee profile, the potential client accesses a screen to enter a valid email address. In an embodiment, the potential client enters identity information. In another embodiment, the potential client may enter educational qualifications and training certifications. In an embodiment, the potential client may enter prior work history.

In an embodiment of the integrated staffing system, an approved client is prompted to enter financial information. In another embodiment, the approved client may enter time keeping data. In another embodiment of the integrated staffing system, the client portal is also configured to display the nearest work assignments to the approved client, based on the information entered by the approved client.

The staffing portal is used by a staffing agent and is configured to aid in the placement of an approved client with a work assignment. Based on the requirements entered for each work assignment, and the employee information from each of the approved clients, the staffing module utilizes a point system to prioritize the pool of approved clients. The staffing module may create a list based on the accumulated points for each of the approved clients. Using this prioritized list, a staffing agent may look at all relevant information and then determine the most suitable approved client for the work assignment. In an embodiment, the staffing module is also configured to determine a market opportunity based at least in part on the employee information.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 illustrates a block diagram of a network architecture suitable for carrying data and programs in accordance with some aspects of the invention;

FIG. 2 illustrates a block diagram of an exemplary computer system according to an embodiment of the present disclosure;

FIG. 3. illustrates a block diagram if an integrated staffing system according to an embodiment of the present disclosure; and

FIG. 4 illustrates screens from a customer portal within the integrated staffing system according to an embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

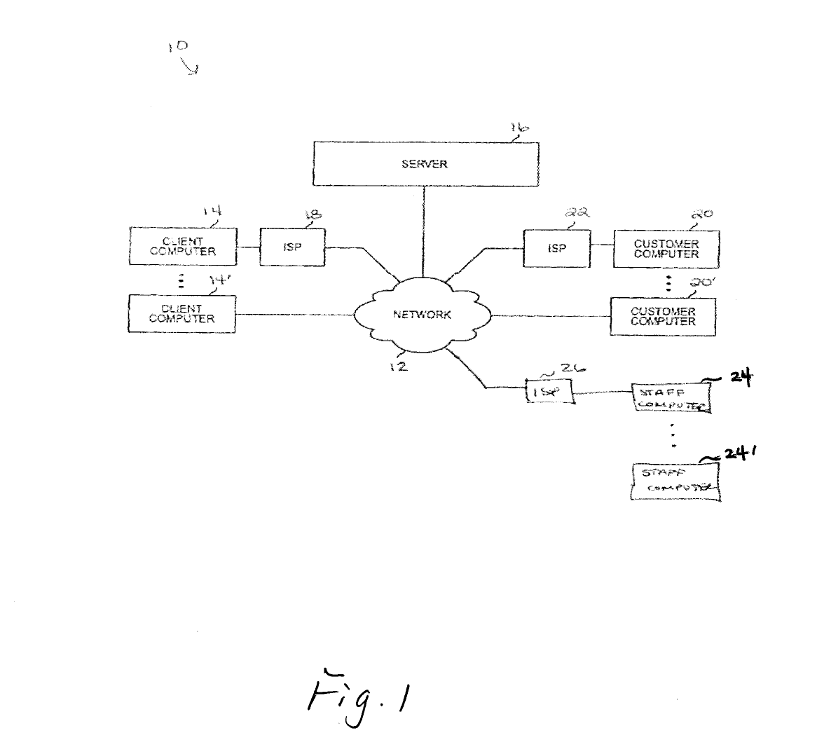

FIG. 1 illustrates an embodiment of a network architecture, generally indicated at 10, suitable for carrying data and programs in accordance with some aspects of the present disclosure. As shown, a network 12 serves to connect one or more client computers 14, 14′ with an integrated staffing system hosted on a server 16.

The one or more client computers 14, 14′ can also connect to the network 12 via a network service provider, such as an internet service provider (ISP) 18. The one or more client computers 14, 14′ are used by potential employees to interact with the integrated staffing system on the server 16 to input client information, apply for employment, review potential employers, complete training modules, etc., to name a few non-limiting examples.

The network 12 also serves to connect one or more customer computers 20, 20′ with the integrated staffing system hosted on the server 16. The one or more customer computers 20, 20′ can also connect to the network 12 via a network service provider, such as an internet service provider (ISP) 22. The one or more customer computers 20, 20′ are used by the customer, e.g., potential employer, to provide information about a job opening to the server 16.

The network 12 also serves to connect one or more staff computers 24, 24′ with the integrated staffing system hosted on the server 16. The one or more staff computers 24, 24′ can also connect to the network 12 via a network service provider, such as an internet service provider (ISP) 26. The one or more staff computers 24, 24′ are used to manage staffing requirements and determine potential job placement opportunities.

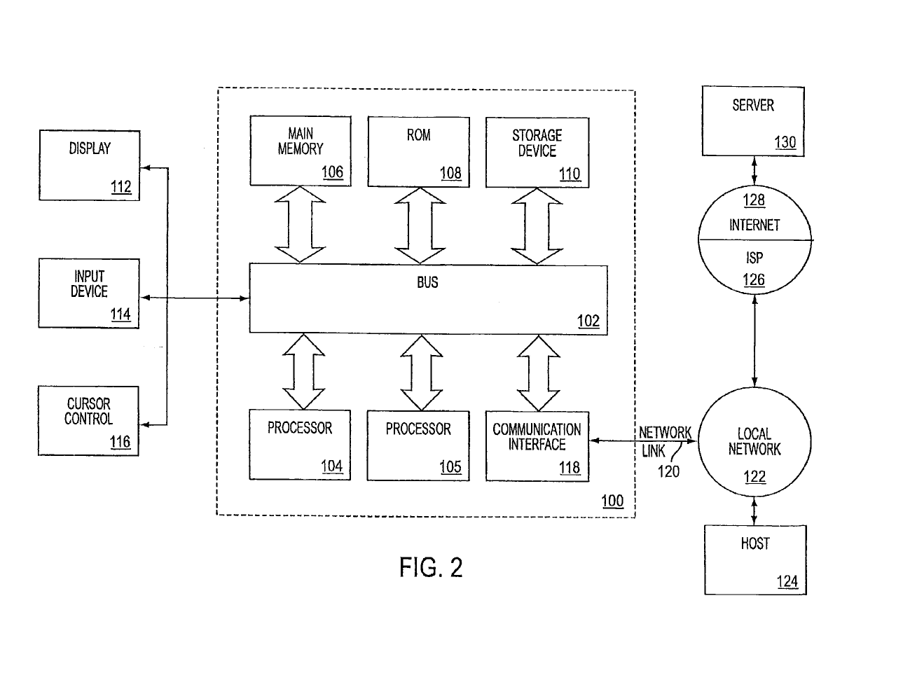

FIG. 2 illustrates a block diagram of an exemplary computer system, generally indicated at 100, which can be utilized to carry out an embodiment of the present disclosure. The computer system 100 can be used for a client computer 14, 14′, customer computer 20, 20′, staff computer 24, 24′ and/or the server 16.

Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the Internet 128. Local network 122 and Internet 128 both use electrical, electromagnetic or optical signals that carry digital data streams. The signals sent through the various networks, the signals on network link 120 and the signals sent through communication interface 118, which carry the digital data to and from computer system 100, are exemplary forms of carrier waves transporting the information.

Computer system 100 can send messages and receive data, including program code, through the network(s), network link 120, and communication interface 118. For example, a server 130 might transmit a requested code for an application program through Internet 128, ISP 126, local network 122 and communication interface 118. In accordance with the present disclosure, one such downloaded application provides for the integrated staffing system as described herein. The received code may be executed by processor 104 as it is received, and/or stored in storage device 110, or other non-volatile storage for later execution. In this manner, computer system 100 may obtain application code in the form of a carrier wave.

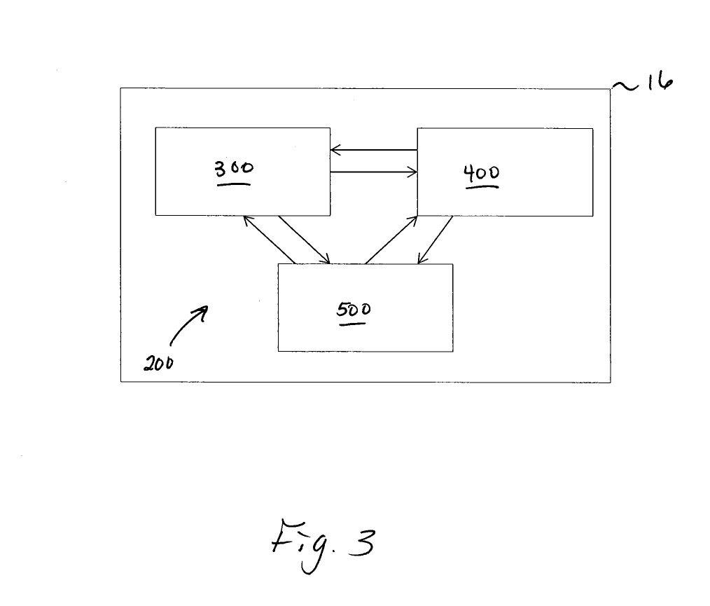

FIG. 3 illustrates a block diagram of an integrated staffing system, stored on the server 16, and used over the network 12, generally indicated at 200, in accordance with an embodiment of the invention. The integrated staffing system 200 is configured to establish a data interface between at least one customer, a plurality of clients, and a staffing agency. The integrated staffing system 200 is further configured to capture client information from the plurality of clients via a client portal 300, capture customer information from the at least one customer via a customer portal 500, operate a staffing portal 500 to utilize a point system based at least in part on the employee information to prioritize the plurality of employees to form a market opportunity list, and determine a market opportunity based at least on part on the market opportunity list.

For the purposes of the present disclosure, clients are defined as potential employees, e.g., job applicants suitable for employment. Customers are defined as potential employers seeking clients to fill needed job assignments. Staffing is defined as one or more employees of a staffing agency. The clients interact with the client portal 300 of the integrated staffing system 200 via the client computer 14, customers interact with the customer portal 400 of the integrated staffing system 200 via the customer computer 20, and staffing interact with the staffing portal 500 of the integrated staffing system 200 via the staffing computer 25.

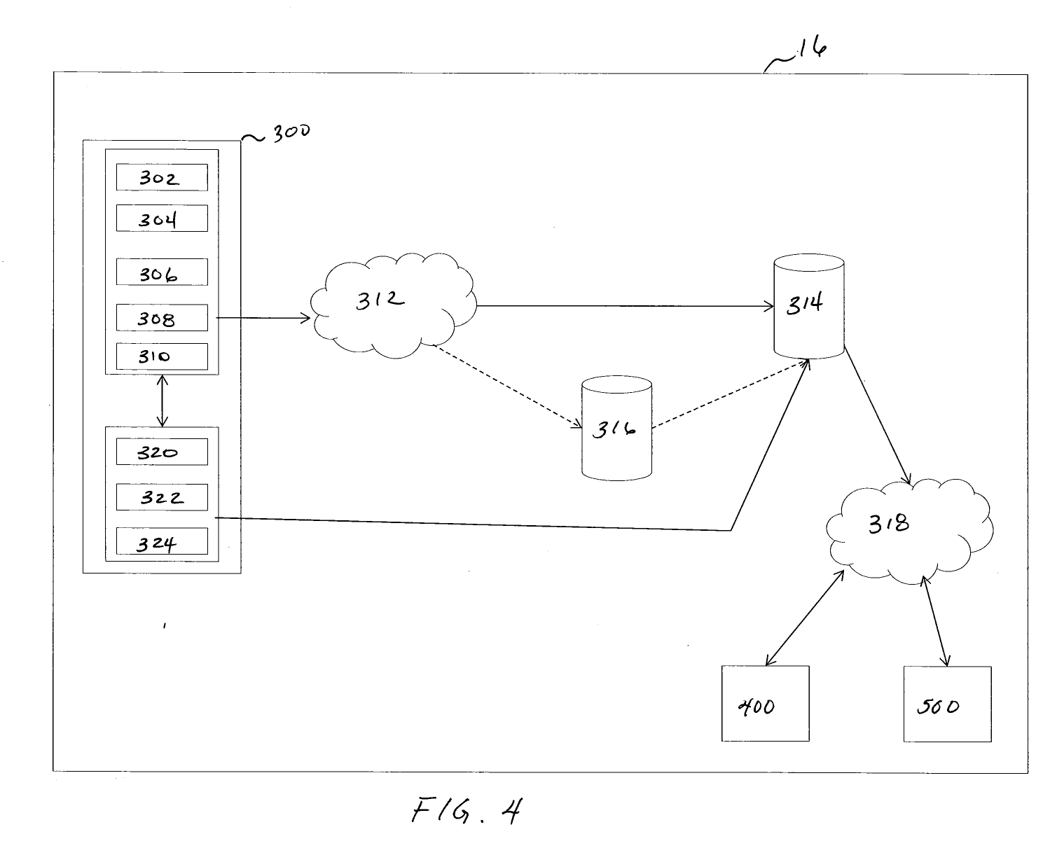

A potential client may interact with the integrated staffing system 200 via a client portal 300, as shown in FIG. 4. The client portal 300 includes a plurality of client modules 302-312 configured to collect client information, facilitate client interactions, and provide training. It will be appreciated that more modules may be available that are depicted in FIG. 4. In other embodiments, the client portal 300 may also capture referral information.

For example, the potential client may access module 302 to create an account, and module 304 to submit an application to become an employee by creating an employee profile. To create an employee profile, the potential client may be required to enter a valid email address, and an acceptable password, the email address being operable for the client to receive communication from the customer module 400 and/or staffing module 500.

The potential client may then enter other identity information such as legal name, residential information, phone number, educational qualifications and training certifications, such as, applicable skills, qualifications, and education by choosing any of the relevant areas within module 306. Module 308 may be used to securely obtain and submit client financial information such as bank account numbers and relevant tax information, such as withholding allowances, number of exemptions, county of residence, and county of employment to name a few non-limiting examples. Module 310 may be used to complete and track pre-requisite training. It will be appreciated that the modules may be used to gather any relevant information about a potential client.

Once the client completes the relevant modules 302-310 to enter appropriate client information, the client information is complied within a client application 312 and transmitted to a database 314. Within database 314, the client information may be catergorized and sorted based on relevant parameters (e.g. location, education, etc.) selected by the staffing agency. The client information within database 314 then becomes accessible to the customer portal 400 and the staffing portal 500 via a staffing application 318.

In some embodiments, client information may be compiled and transmitted to an intermediate database 316. The intermediate database 316 may be configured to copy/sync the client information to database 314 to provide a redundancy of client information for verification purposes.

The client portal 300 may also include certain modules that are only available after the client is retained for employment. For example, module 320 may allow the client to enter and track time entry information. Module 322 may be used for communicating and tracking job information, such as response rates to job openings, affinity to particular types of work, etc. Module 324 may be used for conducting and tracking job related training modules. It will be appreciated that additional objects may be added in the client portal 300 for post-employment functions. These post-employment modules 320-324 transmit the client information to the database 314 to become accessible to the customer portal 400 and the staffing portal 500 via a staffing application 318.

A customer may interact with the integrated staffing system 200 via the customer portal 400. The customer portal 400 is used by customers, and configured to capture customer information. In an embodiment, customer information includes work assignment information for certain positions or particular projects on an as needed basis. In an embodiment, the work assignment information includes at least one job opening, at least one requirement for each of the at least one job opening, and a location for each of the at least one job openings.

To gain access the customer portal 400, the customer may enter a valid user name and password from a customer computer 20, 20′. It will be appreciated that more than one customer may access the customer portal 400 at any given time. In one embodiment, after the user name and password are accepted, the customer may be presented with an option of reviewing a summary of the latest work assignments.

In an embodiment, the customer information may include at least one of an option to start a new work assignment; view a list of open work assignments via an open project; and view a list of closed work assignments. The customer information may also include a review of any documents associated with a customer account and stored on the server 16 via a documents option. For example, the customer may review invoices within the documents option to name one non-limiting example. The customer may receive helpful information about how to operate the customer portal 400 of the integrated staffing system 200 via a help link. In one embodiment, the customer portal 400 is configured to capture performance data for each of the clients relative to a work assignment. In an embodiment, the customer may view and generate a report of the performance data related to any particular work assignment. For example, the customer may look a failure data, the number of hours worked on a project, and each client working on a project to name a view non-limiting examples.

With reference back to FIG. 3, the staffing portal 500 is used by a staffing agent and is configured to aid in the placement of an approved client with a work assignment entered by a client. For example, based on the requirements entered for each work assignment, and the client information from each of the approved clients, the staffing module 500 utilizes a point system to prioritize the pool of approved clients. In some embodiments, predetermined point values may be assigned to an approved client based on at least one of a tenure with the staffing agency, level of training, prior interactions with the customer, demographics, work history, and location of the client in relation to the customer. The staffing module 500 may then create a prioritized list based on the accumulated points for each of the approved clients. Using this prioritized list, a staffing agent may look at all relevant information and then determine the most suitable approved client for the work assignment.

In an embodiment, the staffing module is also configured to determine a market opportunity based at least in part on the client information. For example, the staffing module 500 may examine the accumulated points for the approved clients. If it shown that a number of approved clients, with high accumulated point totals, are within a specific geographic region, the staffing module 500 determines that a marketing opportunity is present within that region, and may alert a staffing agent to the marketing opportunity to take the appropriate action.

It will therefore be appreciated that the integrated staffing system 200 operates to rank a list of approved clients in order to determine the best client to complete a work assignment, and improve the satisfaction of the customer, and to place prospective marketing materials and advertising in locations that have the highest ranking clients.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A system for managing staffing functions via a network, the system comprising:
an integrated staffing system communicatively coupled to the network, the integrated staffing system being configured to:
establish a data interface between at least one employer, a plurality of employees, and a staffing agency;
capture employee information from the plurality of employees via the data interface;
assign predetermined point values to the employee information captured from each of the plurality of employees;
create a market opportunity list based at least in part on the point values assigned to each of the employees; and
determine a market opportunity based at least on part on the market opportunity list.

2. The system of claim 1, wherein the integrated staffing system is further configured to:
capture time keeping data for each of the plurality of employees;
capture financial information for each of the plurality of employees; and
process payroll based at least in part on the time keeping data and the financial information for each of the plurality of employees.

3. The system of claim 1, wherein the integrated staffing system is further configured to:
administer a training course for each of the plurality of employees; and
capture training data for each of the plurality of employees.

4. The system of claim 1, wherein the integrated staffing system is further configured to:
view a project assigned to each plurality of employees;
capture performance data for each of the plurality of employees relative to a work assignment; and
generate a report based at least on the performance data.

5. The system of claim 1, wherein the employee information comprises at least one of:
identity information;
educational qualifications;
training certifications; and
prior work history.

6. The system of claim 1, wherein the integrated staffing system is further configured to
capture work assignment information from the at least one employer via the data interface;
utilize the points assigned to each of the employees and the work assignment information to prioritize the plurality of employees to create an assignment list;
automatically assign an employee to a work assignment based at least in part on the assignment list; and
notify the assigned employee of the work assignment.

7. The system of claim 6, wherein the work information comprises at least one of:
at least one job opening;
at least one requirement for each of the at least one job opening; and
a location for each of the at least one job opening.

8. A method for integrating staffing functions over a network, the method comprising the steps:
establishing a data interface between at least one employer, a plurality of employees, and a staffing agency;
capturing employee information from the plurality of employees via the data interface;
assigning predetermined point values to the employee information captured from each of the plurality of employees;
creating a placement opportunity list based at least in part on the point values assigned to each of the employees; and
determining a placement opportunity based at least in part on the employee information.

9. The method of claim 8, further comprising:
capturing time keeping data for each of the plurality of employees;
capturing financial information for each of the plurality of employees; and
processing a payroll based at least in part on the time keeping data and the financial information for each of the plurality of employees.

10. The method of claim 8, further comprising:
administering a training course for each of the plurality of employees; and
capturing training data for each of the plurality of employees.

11. The method of claim 8, further comprising:
capturing performance data for each of the plurality of employees relative to a project; and
generating a report based at least on the performance data.

12. The method of claim 8, wherein the employee information comprises at least one of:
identity information;
educational qualifications;
training certifications; and
prior work history.

13. The method of claim 8, further comprising:
capturing work assignment information from the at least one employer via the data interface;
utilizing the points assigned to each of the employees and the work assignment information to prioritize the plurality of employees to create an assignment list;
automatically assigning an employee to a work assignment based at least in part on the assignment list; and
notifying the assigned employee of the work assignment.

14. The method of claim 13, wherein the work information comprises at least one of:
at least one job opening;
at least one requirement for each of the at least one job opening; and
a location for each of the at least one job opening.
